(19) United States
(12) Patent Application Publication
(10) Pub. No.: US 2022/0041284 A1
(43) Pub. Date: Feb. 10, 2022

(54) ARRANGEMENT OF SEAT UNITS, IN PARTICULAR FOR AN AIRCRAFT

(71) Applicant: Safran Seats, Plaisir (FR)

(72) Inventors: Arthur Glain, Boulogne Billancourt (FR); Oscar Ruiz, Versailles (FR); Charles Ehrmann, Les Breviaires (FR)

(21) Appl. No.: 17/415,384

(22) PCT Filed: Dec. 10, 2019
(86) PCT No.: PCT/EP2019/084443

§ 371 Date: Jun. 17, 2021

(30) Foreign Application Priority Data
Dec. 18, 2018 (FR) 1873144

(51) Int. Cl. B64D 11/06

(52) U.S. Cl. CPC B64D 11/0601; B64D 11/0641; B64D 11/0606; B64D 11/0604

(57) ABSTRACT

The present invention relates to an arrangement of individual seat units intended to be installed in particular in an aircraft cabin, characterized in that a console of a seat unit of a given row is arranged in the vicinity of a seat of a seat unit of the other row so as to define a space for stowing and/or placing objects, and in that said arrangement has access passages for access to a traffic aisle, an access passage being delimited at least in part on the one hand by a shell of a seat unit of the second row and on the other hand by an adjacent console of a seat unit of the second row, in such a way that each access passage allows direct access to the traffic aisle (14) for a passenger of a seat belonging to the first row.

The present invention relates to an assembly of seat units, in particular for an aircraft. The invention finds a particularly advantageous application with aircraft seats of the ‘business class’ type. The invention can also be implemented with seats for other means of transport, such as for example seats for buses, trains or boats.

Aircraft seats of the ‘Business class’ type offer passengers different comfort positions from the ‘seating’ position to a ‘lying’ position in which the seat defines a substantially horizontal lying surface for the passenger.

Intermediate comfort positions are also available, such as the ‘relax’ position in which the backrest is strongly inclined. Generally, these positions are obtained by tilting the backrest, pivoting about a horizontal axis. The passenger can then remain in the seat during transitions among the different positions.

Document U.S. Pat. No. 7,178,871 describes an assembly of individual seats to be installed in an aircraft cabin. This seat assembly includes a first row of seat units arranged behind one another and facing a first direction of the aircraft cabin, and a second row of seat units arranged behind one another and facing a second direction of the aircraft cabin, opposite the first direction. The second row of seat units is arranged on the side of an aisle, as it is shown in particular in FIG. 11. Each seat unit comprises a seat convertible between a seating position and a lying position, a console comprising a foot zone for receiving the feet of the passenger seated in the corresponding seat, and a privacy shell at least partially surrounding the seat.

However, the drawback of such a configuration is that the passengers in the seats of the first row do not have direct access to the aisle. Indeed, in order to access the aisle, the passengers in the first row must enter the living space of the passengers in the second row, which affects their privacy. In addition, the living space is reduced and does not provide any storage space for the passenger.

The invention aims at effectively remedying these drawbacks by providing an assembly of individual seat units to be installed in particular in an aircraft cabin, said assembly comprising:
a first row of seat units arranged behind one another and facing a first direction of the aircraft cabin,
a second row of seat units arranged behind one another and facing a second direction of the aircraft cabin, opposite the first direction, the second row of seat units being arranged on the side of an aisle,
each seat unit comprising a seat convertible between a seating position and a lying position, a console comprising a foot zone for receiving the feet of the passenger seated in the corresponding seat, and a privacy shell,
   characterized in that a console of a seat unit in a given row is arranged near a seat of a seat unit in the other row to define a space for storing and/or placing objects,
and in that said assembly includes access passages to an aisle, an access passage being at least partly delimited by a shell of a seat unit in the second row on the one hand and by an adjacent console of a seat unit in the second row of on the other hand, so that each access passage allows a passenger in a seat in the first row of seat units a direct access to the aisle.

The invention thus allows all the airplane passengers a direct access to the aisle, while optimizing the density of seat units in the airplane cabin. In addition, the positioning of the seats in the two rows in two opposite directions makes it possible to maximize the space available for a passenger, when the seat is in a seating or lying position. The invention also improves the living space of each passenger by providing storage spaces formed by the consoles in the adjacent column of seat units.

According to one embodiment, the seat units in the first row and the seat units in the second row are arranged in blocks of two seat units, each block comprising a seat unit in the first row and a seat unit in the second row.

According to one embodiment, each block of two seat units comprises a first seat facing the first direction of the aircraft cabin and a second seat facing the opposite second direction of the aircraft cabin.

According to one embodiment, the first seat and the second seat of each block overlap longitudinally at the backrest.

According to one embodiment, the shells of the seats of a block are integral with one another.

According to one embodiment, an axis of an access passage forms a non-zero angle with respect to a straight line perpendicular to an axis of the aircraft cabin.

According to one embodiment, a surface of a seat in the lying position and a surface of a foot zone located in an extension of said seat in the lying position define a bed surface of a corresponding seat unit.

According to one embodiment, a larger dimension of the bed surface of a seat unit in the second row forms a non-zero angle with respect to an axis of the aircraft cabin.

According to one embodiment, a pitch between two seat units in the first row is equal to a pitch between two seat units in the second row.

According to one embodiment, the pitch between two seat units in the first row or the second row is comprised between 70 and 85 inches and is preferably equal to 75 inches.

The invention also relates to an aircraft cabin characterized in that it comprises at least one assembly of seat units as defined above.

The present invention will be better understood and other features and advantages will become apparent on reading the following detailed description including embodiments, given as illustrative examples, with reference to the accompanying figures, given as non-limiting examples, which could be used to completely understand the present invention and the description of its implementation and which could contribute, if need be, to its definition, in which:

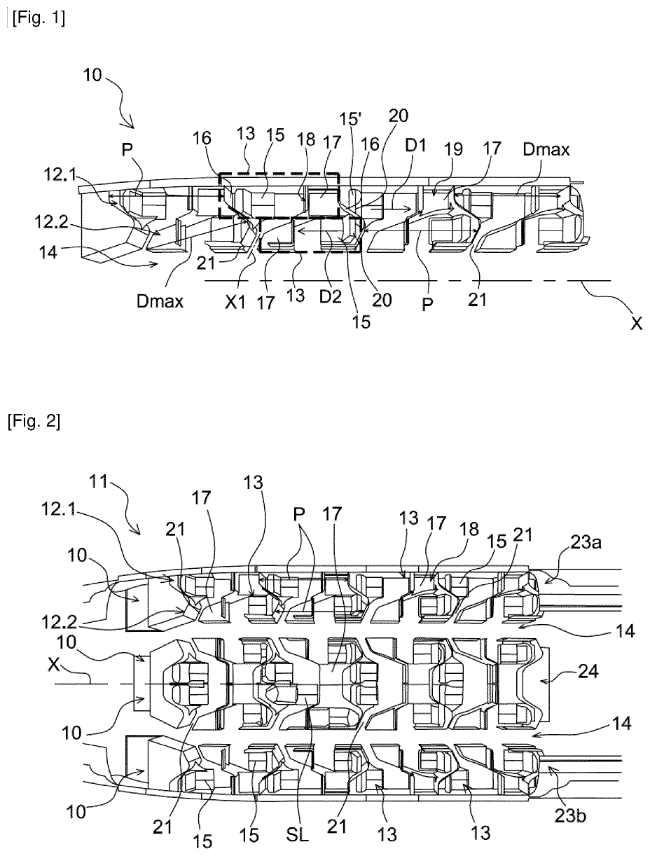

FIG. 1 is a top view of an assembly of seat units according to the present invention;

FIG. 2 is a top view of an aircraft cabin including assemblies of seat units according to the invention;

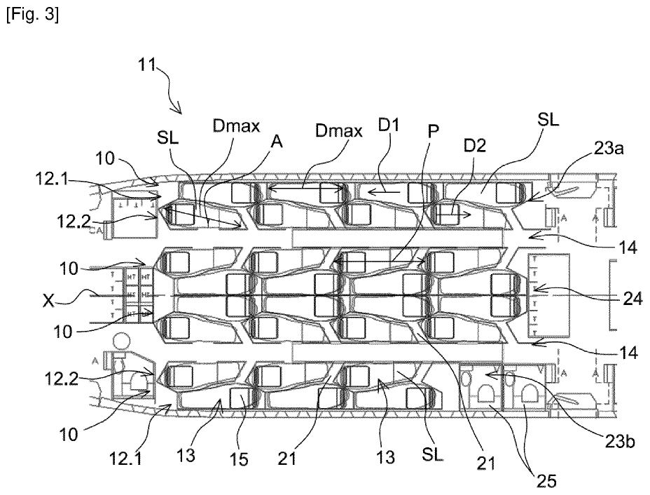

FIG. 3 is a top view of an aircraft cabin including assemblies of seat units according to the invention showing the layouts of the bed surfaces of the seat units.

It should be noted that, in the figures, the structural and/or functional elements common to the different embodiments may have the same references. Thus, unless otherwise stated, such elements have identical structural, dimensional and material properties.

FIG. 1 shows an assembly 10 of individual seat units 13 to be installed in an aircraft cabin 11 of longitudinal axis X. This assembly 10 comprises a first row 12.1 of seat units 13 arranged behind one another and facing a first direction D1 of the aircraft cabin 11, and a second row 12.2 of seat units 13 arranged behind one another and facing a second direction D2 of the aircraft cabin 11, opposite the first direction D1. The direction D1 could for example be directed towards the airplane front, that is to say towards the cockpit, and the direction D2 towards the airplane rear, or vice versa.

The second row 12.2 of seat units 13 is arranged on the side of an aisle 14. The first row 12.1 of seats may be arranged on the side of the aircraft fuselage or in a central part of the airplane, that is to say in a zone which does not allow access to the aisle 14 without crossing the second row 12.2 of seat units.

Each seat unit 13 comprises a seat 15 convertible between a ‘sitting’ position, corresponding to the position used in particular during the stopping, takeoff, and landing phases of the aircraft, and a ‘lying’ position, in which the seat 15 defines a substantially horizontal plane for the passenger. In particular, the ‘sitting’ position and the ‘lying’ position are configurations of the seat 15 in two extreme positions. According to variant embodiments, the seat may also take intermediate positions, called relax positions, between these two extreme positions.

A privacy shell 16 at least partially surrounds each seat 15. For the seats on the side of the aisle 14, the shell 16 extends along one side of the seat 15 along the aisle 14.

In addition, a console 17 comprises a foot zone 18 for receiving the feet of the passenger in the seat 15 of the corresponding unit 13, in particular when the seat 15 is in the lying position. For this purpose, the console 17 has an opening directed towards the passenger of the corresponding seat behind the console 17. The flat surface of a seat 15 in the lying position is intended to be located in the extension of the foot zone 18, such that the surface of the seat 15 in the lying position and the surface of the foot zone 18 define a bed surface SL.

The console 17 of a seat unit 13 in a row 12.1, 12.2 given is disposed near a seat 15 of a seat unit 13 in the other row in order to define a space 19 for storing and/or placing objects. For this purpose a console 17 includes a flat upper wall on which the passenger in the adjacent seat 15 can in particular place objects. The upper wall can thus be used as a table, a working surface, a dining table, a cocktail table or any other usable surface for a passenger in the adjacent seat 15. The console 17 may also include storage spaces such as magazine rack, drawers, or the like.

In other words, at least part of the console 17 comprising the foot zone 18 of a seat unit 13 in the first row 12.1 extends into the space occupied by a passenger seated in a seat 15 adjacent to the second row 12.2 and vice versa. The console 17 thus defines a space for storing and/or placing objects for a passenger seated in a seat 15 in the row adjacent to that in which the console 17 is placed.

The assembly 10 comprises access passages 21 to an aisle 14. An access passage 21 is delimited at least in part by a shell 16 of a seat unit 13 in the second row 12.2 on the one hand and by an adjacent console 17 of a seat unit 13 in the second row 12.2 on the other hand, such that each passage 21 allows a passenger in a seat 15 in the first row 12.1 of seat units 13 direct access to the aisle 14. An axis X1 of an access passage 21 preferably forms a non-zero angle with respect to a straight line perpendicular to the longitudinal axis X of the aircraft cabin 11.

Advantageously, the seats 15 in the first row 12.1 and in the second row 12.2 are organized in blocks 22 of two seat units 15, each block 22 including a seat unit 13 in the first row 12.1 and a seat unit 13 in the second row 12.2. Each block 22 includes a first seat 15 facing the direction D1 of the aircraft cabin 11 and a second seat 15 facing the opposite direction D2 of the aircraft cabin 11.

The first seat 15 and the second seat 15′ of each block 22 overlap longitudinally along their backrest 20, such as it is shown in FIG. 1. Thus, there is an overlap at the shoulders of two passengers positioned side by side but facing two opposite directions D1, D2.

The shells 16 of the seats 15 of the same block 22 are integral with one another. The term ‘integral’ means that the shells 16 of the two seats 15 may be produced from the same piece, obtained for example by molding, or from several pieces assembled together by suitable fixing means.

According to one embodiment, a pitch P between two seat units 13 in the first row 12.1 is the same as a pitch between two seat units 13 in the second row 12.2. It will be recalled that a pitch P corresponds to the distance between two reference points of two adjacent seat units located behind one another in the same row.

The pitch P between two seat units 15 in the first row 12.1 or in the second row 12.2 is comprised between 70 and 85 inches and is preferably equal to 75 inches.

Compared to the first row 12.1, the longitudinal dimensions of the seat units 13 in the second row 12.2 are reduced due to the presence of the access passages 21 to the aisle 14. In order to compensate for this loss of space, a greater dimension Dmax of the bed surface SL of a seat 15 in the second row 12.2 forms a non-zero angle A with respect to the axis X of the aircraft cabin 11, as it can be seen in FIGS. 1 and 3. This angle A is for example comprised between 3 and 20 degrees. As the seat units 13 in the first row 12.1 do not have any particular space constraint, a greater dimension Dmax of their bed surface SL extends along the axis X of the aircraft cabin. Indeed, the seat units 13 in the first row 12.1 take advantage of the lack of access passage to an aisle 14 to optimize the dimensions of their bed surface SL.

FIGS. 2 and 3 show an aircraft cabin 11 comprising several assemblies 10 of seat units 13. There are two side groups 23a, 23b comprising seat units 13. The two side groups 23a, 23b are respectively formed by two rows of seat units 13 positioned along a side wall of the fuselage of the aircraft cabin 10. In addition, a central group 24 is preferably formed by two sets of two rows, i.e. four rows of seat units 13 in all. In such an assembly, the rows of seat units 13 of the central group 24 are advantageously contiguous laterally with respect to one another.

The principle of the assembly in FIG. 1 is thus reproduced four times: once in each side group 23a, 23b and twice in the central group 24, so that there is a symmetry with respect to the axis X of the aircraft cabin 10. In FIG. 3, this symmetry is observed except in the zone for the toilet modules on the side of the lateral group 23b.

The side groups 23a, 23b are respectively separated from the central group 24 by an aisle 14. According to the configuration shown, two aisles 14 are therefore provided in the aircraft cabin 10, specifically between each side group 23a, 23b and the central group 24. As a variant, the two side groups 23a, 23b may each be formed by more than two rows of seat units 13. The central group 24 may also include only two rows of seat units 13.

Thanks to the invention, all the seats 15 have direct access to a corresponding aisle 14, including the furthest seats of the side groups 23a, 23b from the aisle 14 via an access passage 21, such as it has been previously described.

Of course the different features, variants and/or embodiments of the present invention can be associated with one another in various combinations insofar as they are not incompatible or exclusive with one another.

Obviously, the invention is not limited to the embodiments described above and provided by way of example only. It encompasses various modifications, alternative forms and other variants a person skilled in the art may consider in the context of the present invention and in particular any combination of the various operating modes described above, which may be taken separately or in combination.

1. An assembly of individual seat units to be installed in particular in an aircraft cabin, said assembly comprising:
a first row of seat units arranged behind one another and facing a first direction of the aircraft cabin,
a second row of seat units arranged behind one another and facing a second direction of the aircraft cabin, opposite to the first direction, the second row of seat units being arranged on the side of an aisle,
each seat unit comprising a seat convertible between a sitting position and a lying position, a console comprising a foot zone for receiving the feet of the passenger seated in the corresponding seat, and a privacy shell,
characterized in that a console of a seat unit in given row is arranged near a seat of a seat unit in the other row to define a space for storing and/or placing objects,
and in that said assembly includes access passages to an aisle, an access passage being at least in part delimited by a shell of a seat unit in the second row on the one hand and by an adjacent console of a seat unit in the second row on the other hand, so that each access passage allows a passenger in a seat in the first row of seat units a direct access to aisle.

2. The assembly of seat units according to claim 1, characterized in that the seat units in the first row and the seat units in the second row are arranged in blocks of two seat units, each block comprising a seat unit in the first row and a seat unit in the second row.

3. The assembly of seat units according to claim 2, characterized in that each block of two seat units comprises a first seat facing the first direction of the aircraft cabin and a second seat facing the opposite second direction of the aircraft cabin.

4. The assembly of seat units according to claim 3, characterized in that the first seat and the second seat of each block overlap longitudinally at a backrest of these seats.

5. The assembly of seat units according to claim 2, characterized in that the shells of the seats of a block are integral with one another.

6. The assembly of seat units according to claim 1, characterized in that an axis of an access passage forms a non-zero angle with respect to a straight line perpendicular to an axis of the aircraft cabin.

7. The assembly of seat units according to claim 1, characterized in that a surface of a seat in the lying position and a surface of a foot zone located in an extension of said seat in the lying position define a bed surface of a corresponding seat unit.

8. The assembly of seat units according to claim 7, characterized in that a larger dimension of the bed surface of a seat unit in the second row forms a non-zero angle with respect to an axis of the aircraft cabin.

9. The assembly of seat units according to claim 1, characterized in that a pitch between two seat units in the first row is equal to a pitch between two seat units in the second row.

10. The assembly of seat units according to claim 9, characterized in that the pitch between two seat units in the first row or in the second row is comprised between 70 and 85 inches and is preferably equal to 75 inches.

11. An aircraft cabin characterized in that it comprises at least one assembly of seat units as defined in claim 1.
